(19) United States
(12) Patent Application Publication
(10) Pub. No.: US 2026/0239135 A1
(43) Pub. Date: Aug. 13, 2026

(54) RACH BASED L1 AND L2-TRIGGERED MOBILITY METHODS AND RELATED SYSTEMS AND APPARATUSES

(71) Applicant: APPLE INC., Cupertino, CA (US)

(72) Inventors: Fangli Xu, Beijing (CN); Naveen Kumar R Palle Venkata, San Diego, CA (US); Haijing Hu, Los Gatos, CA (US); Wei Zeng, San Diego, CA (US); Yuqin Chen, Beijing (CN); Hong He, San Jose, CA (US); Dawei Zhang, Saratoga, CA (US); Qiming Li, Beijing (CN); Yang Tang, San Jose, CA (US)

(21) Appl. No.: 19/152,259

(22) PCT Filed: Feb. 16, 2023
(86) PCT No.: PCT/CN2023/076438

§ 371 Date: Jul. 30, 2025

(51) Int. Cl. H04W 36/08; H04W 72/23; H04W 74/0833

(52) U.S. Cl. CPC H04W 36/08; H04W 72/23; H04W 74/0833

(57) ABSTRACT

Described herein are apparatuses, systems, and methods for performing a random access channel (RACH) based L1/L2-triggered mobility (LTM) procedure. A UE may receive, from a source primary cell (S-PCell), LTM candidate configuration information for a candidate PCell (C-PCell). The UE may perform a random access channel (RACH) procedure with the S-PCell and the C-PCell and receive an LTM cell switch command. The UE may switch from the S-PCell to the C-PCell while performing the RACH procedure.

### TECHNICAL FIELD

This application relates generally to wireless communication systems, including RACH procedures and L1 and L2-triggered mobility (LTM) procedures.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a signal flow diagram for LTM in accordance with some embodiments.

FIG. 2 illustrates a signal flow diagram of an LTM procedure where the PDCCH order is used as the LTM command for a CBRA case in accordance with some embodiments.

FIG. 3 illustrates a signal flow diagram of an LTM procedure where the PDCCH order is used as the LTM command for a CFRA case in accordance with some embodiments.

FIG. 4 illustrates a signal flow diagram of an LTM procedure where the RAR is used as the LTM command for a CFRA case in accordance with some embodiments.

FIG. 5 illustrates a signal flow diagram of an LTM procedure where the Msg4 is used as the LTM command for a CBRA case in accordance with some embodiments.

FIG. 6 illustrates a flow chart of a method for a UE in accordance with some embodiments.

FIG. 7 illustrates a flow chart of a method for a S-PCell in accordance with some embodiments.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a user equipment (UE).

However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

One objective of wireless communication systems is to support mobility of a UE.

UE mobility may include Layer 1/Layer 2 (L1/L2) inter-cell mobility. Some embodiments herein include mechanisms and procedures of L1/L2 based inter-cell mobility for mobility latency reduction.

Mobility latency may be reduced in a number of ways. For example, enhancements may be made to configuration and maintenance of multiple candidate cells to allow fast application of configurations for candidate cells. Further, a dynamic switch mechanism among candidate serving cells (including SPCell and SCell) may be used for the potential applicable scenarios based on L1/L2 signaling. L1 enhancements for inter-cell beam management may include L1 measurement and reporting and beam indication. Additionally, timing advance management may be enhanced. Further, Centralized Unit-Distributed Unit (CU-DU) interface signaling to support L1/L2 mobility may be considered.

L1/L2-triggered mobility (LTM) is used herein as a term for the L1/L2-triggered mobility. The term cell switch refers to the procedure of triggering change of cells via the LTM feature. The term Subsequent LTM refers to the case when cell switch between L1/L2 mobility candidates is done without radio resource control (RRC) reconfiguration in between.

For candidate cell configuration a L1/L2 inter-cell mobility candidate (target) configuration may be received within an RRC message before the L1/L2 dynamic switch is triggered.

For the cell switch procedure, it may be assumed that L1/L2 mobility trigger information may be conveyed in a medium access control (MAC) control element (CE). The MAC CE or a DCI may be used for the actual triggering. The MAC CE for L1/L2 mobility trigger may contain at least a candidate configuration index. Both random access channel (RACH)-based (e.g., Contention Free Random Access (CFRA), Contention Based Random Access (CBRA)) and RACH-less procedures for L1/L2 mobility switch may be supported. RACH-less may be used if the UE does not need to acquire timing advance (TA) during the cell switch. A RACH resource for CFRA for an L1/L2 dynamic switch may be provided in RRC configuration or potentially by MAC CE. At the L1/L2 cell switch, the network may control whether the UE performs partial or full MAC reset, re-establishes Radio Link Control (RLC), and/or performs data recovery with Packet Data Convergence Protocol (PDCP).

In some embodiments, the MAC CE used for LTM related information for cell switch may also be used for LTM triggering of the cell switch. The LTM cell switch may be supervised by a timer. The UE arrival in the target cell may not need to be indicated.

In some embodiments, a network may support both RACH-less and RACH-based cell switching procedure for L1/L2 inter-cell mobility. The network may support TA acquisition of a candidate cell before cell switching. For example, before cell switching, the UE can acquire the TA of a candidate cell via Physical downlink control channel (PDCCH) order RACH. For PDCCH order RACH on a candidate cell, the PDCCH order may be triggered by a current serving cell.

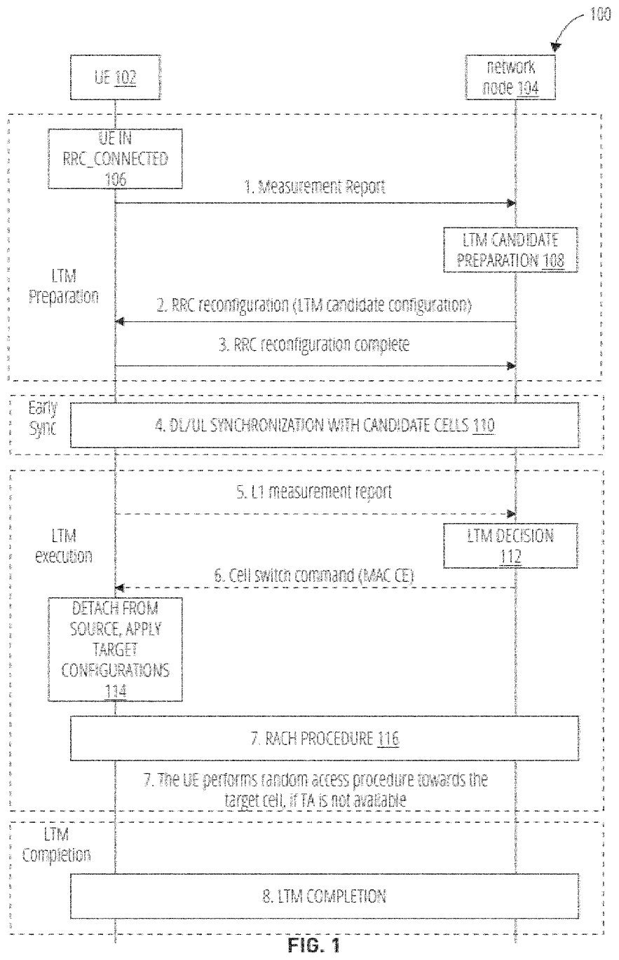

FIG. 1 illustrates a signal flow diagram 100 for LTM. The LTM procedure may include several steps for LTM preparation. As shown, the UE 102 may be in an RRC connected state 106. The UE 102 may send a measurement report to the network node 104. Based on the measurement report, the network node 104 may determine candidate cells and perform LTM candidate preparation 108. The network node 104 may send an RRC reconfiguration message to the UE 102. The RRC reconfiguration message may include an LTM candidate configuration. The UE 102 may send an RRC reconfiguration complete message to the network node 104.

Further, the UE 102 may perform an early synchronization with the candidate cells. For example, the network node 104 may trigger the UE 102 to synchronize with the candidate cells 110. The UE 102 may transmit LI measurement report to the network node 104. The network node 104 may make an LTM decision 112 based on the L1 measurement report. If the network node 104 decides the UE 102 should switch cells, the network node 104 may send a cell switch command via MAC CE to the UE 102. The UE 102 may detach from the source cell and apply target configurations 114.

The UE 102 may switch to the target cell and directly perform the data transmission if the UE 102 has a valid TA. If the TA of the target cell is not available when the UE 102 receives the cell switching command MAC CE, the UE 102 may switch to the target cell and performs RACH procedure to acquire the TA value first. As shown, the LTM command delivery (e.g., MAC CE cell switch command, step 6) and RACH procedure (step 7) are separate steps. However, performing these two steps separately may cause some LTM latency.

In some embodiments herein, cell switching can be performed during the inter-cell RACH procedure to reduce the LTM latency. In other words, step 6 and step 7 can be combined together.

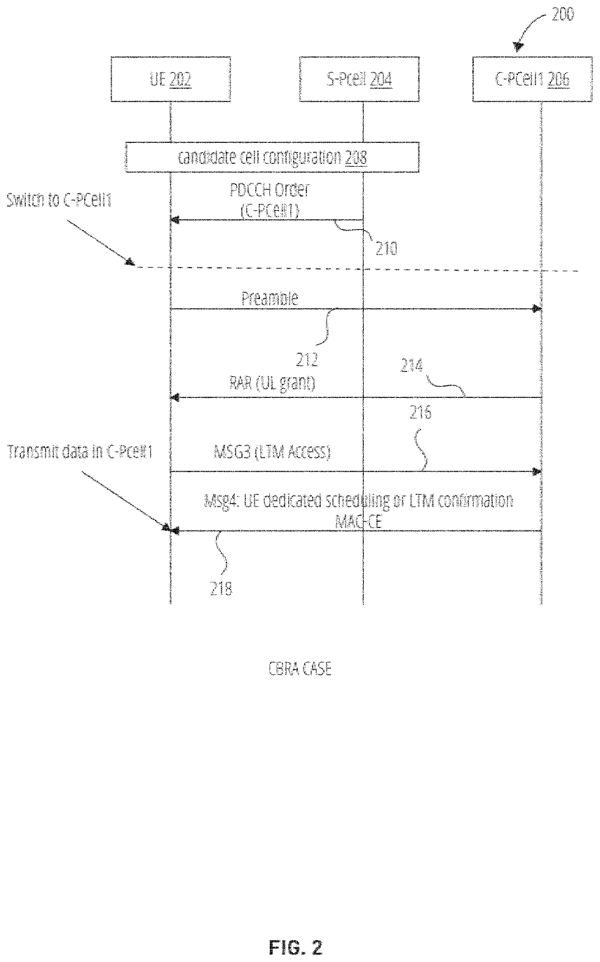

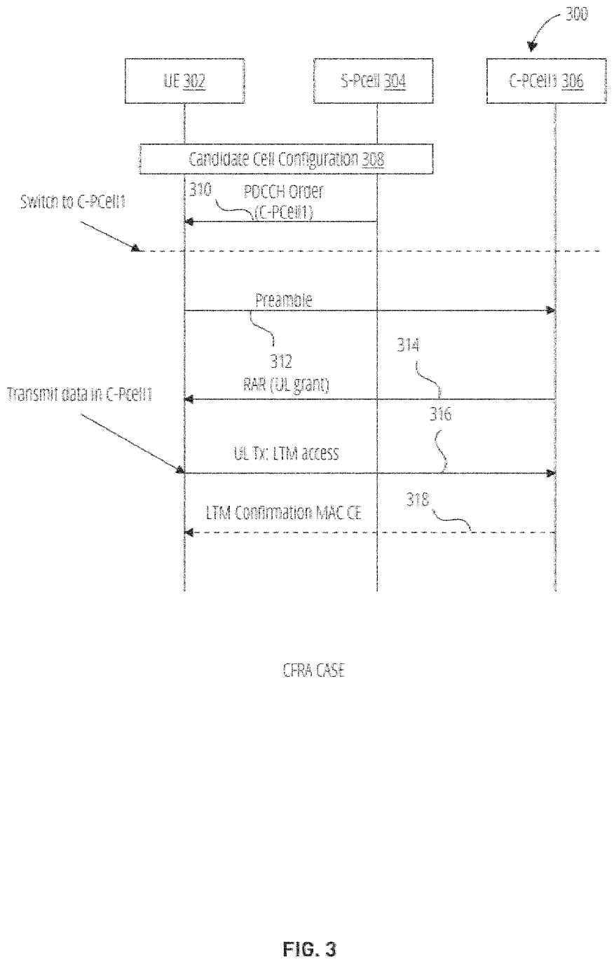

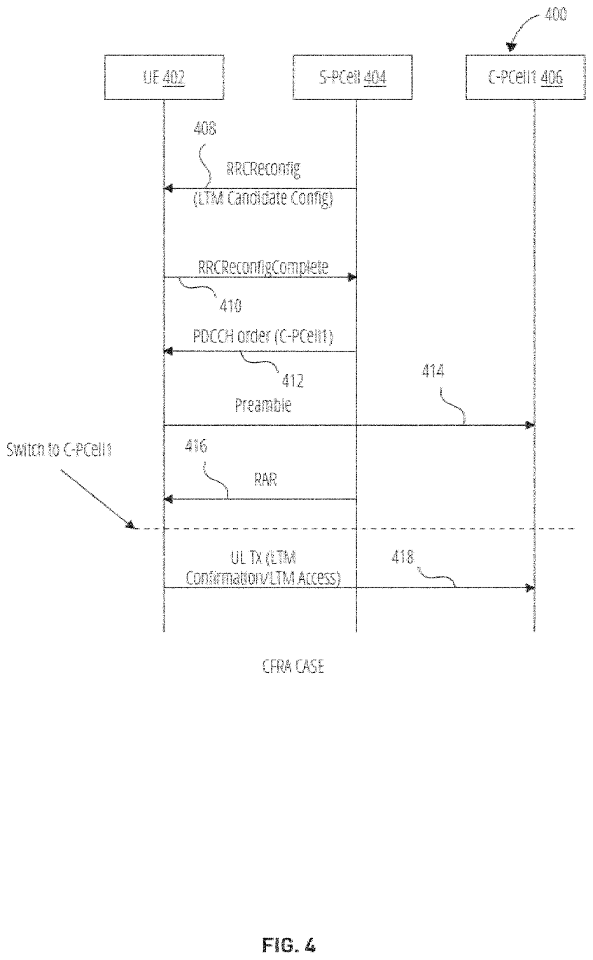

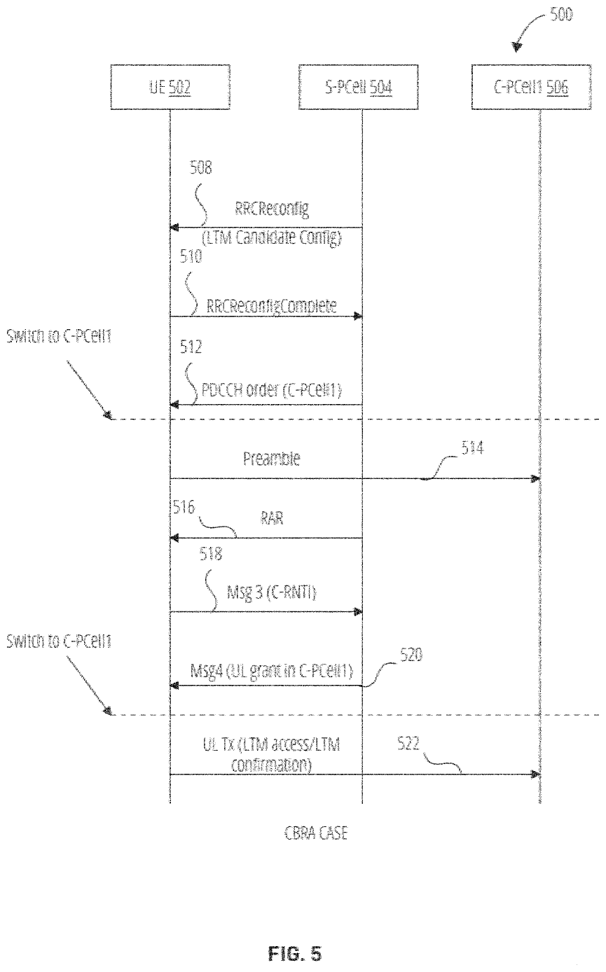

For example, in some embodiments, when the network node decides to switch the UE from source primary cell (S-PCell) to candidate PCell (C-PCell) via RACH based LTM procedure, the network node can deliver the LTM command via a RACH procedure step. In some embodiments, the network node may send the LTM command via a PDCCH order (e.g., FIGS. 2-3). In some embodiments, the network node may send the LTM command via a message 2 (Msg2) Random Access Response (RAR) (e.g., FIG. 4). In some embodiments, the network node may send the LTM command via a Msg4 contention resolution message in a contention based random access (CBRA) case (e.g., FIG. 5).

In the embodiments illustrated in FIGS. 1-5, the UE performs cell switching from S-PCell to C-PCell during the RACH procedure and delivers the LTM access info to the network. The UE operation during the RACH procedure may include no UE dedicated data transmission or reception in C-PCell. Additionally, the UE may keep a dedicated data transmission and reception in S-PCell during the RACH procedure. If the RACH procedure fails, the UE may work with the S-PCell or select a suitable C-PCell to camp on. The UE may inform the network of the C-PCell RACH failure.

FIG. 2 illustrates a signal flow diagram 200 of an LTM procedure where the PDCCH order is used as the LTM command for a CBRA case. The UE 202 and the S-PCell 204 may execute a candidate cell configuration 208. The candidate cell configuration may include the S-PCell 204 transmitting an RRC reconfiguration message to the UE 202. The RRC reconfiguration message may contain an LTM candidate configuration. The UE 202 may transmit an RRC reconfiguration complete message to the S-PCell 204 to indicate reception of the RRC reconfiguration message.

The S-PCell 204 may transmit a PDCCH order 210 to the UE 202 to initiate a RACH procedure. The PDCCH order 210 may be used as an LTM command and may include information related to C-PCell1 206. The PDCCH order 210 may include cell information for the C-PCell1 206. For example, the PDCCH order 210 may include a cell index of C-PCell1 206 or a candidate configuration index of C-PCell1 206. The PDCCH order 210 may also include an LTM command indication that indicates to the UE the purpose of the PDCCH order 210. For example, the LTM command indication may be 1-bit that indicates whether to switch cell or just obtain a second TA for C-PCell1 with cell switching. The PDCCH order 210 may also include a preamble index and PRACH resource that refers to C-PCell1 PRACH configuration.

In some embodiments, when the UE 202 receives the PDCCH order 210, the UE 202 switches to C-PCell1 206 and performs the RACH procedure. The UE 202 may stop the data transmission in S-PCell 204. The UE 202 may apply the C-PCell1 configuration, or apply at least RACH configuration. The UE 202 may perform a CBRA procedure or a CFRA procedure in the C-PCell1 206 as indicated in PDCCH order 210.

During the RACH procedure, the UE 202 may perform the following operations.

The UE 202 may transmit the preamble 212 to the C-PCell1 206. The preamble 212 may be determined using the preamble index and PRACH resource from the PDCCH order 210.

After transmitting the preamble 212, the UE 202 may monitor for a random access response (RAR 214) from the C-PCell1 206.

The C-PCell1 206 may apply for a Temporary Cell Radio Network Temporary Identifier (TC-RNTI) and uplink and downlink scheduling resources. The C-PCell1 206 may send the RAR 214 to the UE 202. The UE 202 may receive the RAR 214 from the C-PCell1 206. The RAR 214 may contain an uplink grant and TC-RNTI. The TC-RNTI in RAR 214 can be the C-RNTI allocated to the UE 202 for dedicated transmission.

Additionally, during the RACH procedure, the UE 202 may transmit LTM access information to the network via an uplink grant indicated in RAR. For example, for the CBRA case shown, the UE 202 transmits the LTM access information to the C-PCell1 206 using Msg3 216. The C-PCell1 206 may transmit a Msg4 218 that includes UE dedicated scheduling or LTM configuration MAC-CE.

In some embodiments, the UE 202 may determine that the LTM procedure is completed when the UE 202 delivers the LTM access information (e.g., via Msg3 216) to the C-PCell1 206. In some embodiments, the UE 202 may determine that the LTM procedure is completed when the UE 202 receives network LTM confirmation. The LTM confirmation may be the MAC CE (e.g., via Msg4 218).

In some embodiments, the UE 202 may use an LTM timer to help the UE 202 detect failure cases. For example, the UE 202 may assume the LTM procedure failed upon RACH failure or when the LTM timer expires. In some embodiments, the LTM timer may be started when the UE 202 receives the PDCCH order 210. In some embodiments, the LTM timer may be started when the UE 202 transmits the preamble 212 to the C-PCell1 206.

FIG. 3 illustrates a signal flow diagram 300 of an LTM procedure where the PDCCH order is used as the LTM command for a CFRA case. The signaling may be very similar to the signal flow diagram 200 of FIG. 2. The UE 302 and the S-PCell 304 may execute a Candidate cell configuration 308. The candidate cell configuration may include the S-PCell 304 transmitting an RRC reconfiguration message to the UE 302. The RRC reconfiguration message may contain an LTM candidate configuration. The UE 302 may transmit an RRC reconfiguration complete message to the S-PCell 304 to indicate reception of the RRC reconfiguration message.

The S-PCell 304 may transmit a PDCCH order 310 to the UE 302 to initiate a RACH procedure. The PDCCH order 310 may be used as an LTM command and may include information related to C-PCell1 306. The PDCCH order 310 may include cell information for the C-PCell1 306. For example, the PDCCH order 310 may include a cell index of C-PCell1 306 or a candidate configuration index of C-PCell1 306. The PDCCH order 310 may also include an LTM command indication that indicates to the UE the purpose of the PDCCH order 310. For example, the LTM command indication may be 1-bit that indicates whether to switch cell or just obtain a second TA for C-PCell1 with cell switching. The PDCCH order 310 may also include a preamble index and PRACH resource that refers to C-PCell1 PRACH configuration.

In some embodiments, when the UE 302 receives the PDCCH order 310, the UE 302 switches to C-PCell1 306 and performs the RACH procedure. The UE 302 may stop the data transmission in S-PCell 304. The UE 302 may apply the C-PCell1 configuration, or apply at least RACH configuration. The UE 302 may perform a CBRA procedure or a CFRA procedure in the C-PCell1 306 as indicated in PDCCH order 310.

During the RACH procedure, the UE 302 may perform the following operations.

The UE 302 may transmit the preamble 312 to the C-PCell1 306. The preamble 312 may be determined using the preamble index and PRACH resource from the PDCCH order 310.

After transmitting the preamble 312, the UE 302 may monitor for a random access response (RAR 314) from the C-PCell1 306.

The C-PCell1 306 may apply for a Temporary Cell Radio Network Temporary Identifier (TC-RNTI) and uplink and downlink scheduling resources. The C-PCell1 306 may send the RAR 314 to the UE 302. The UE 302 may receive the RAR 314 from the C-PCell1 306. The RAR 314 may contain an uplink grant and TC-RNTI. The TC-RNTI in RAR 314 can be the C-RNTI allocated to the UE 302 for dedicated transmission.

Additionally, during the RACH procedure, the UE 302 may transmit LTM access information to the network via an uplink grant indicated in RAR. For example, for the CFRA case shown, the UE 302 transmits the LTM access information to the C-PCell1 306 using a UE dedicated UL transmission 316. The C-PCell1 306 may transmit an LTM configuration MAC CE 318.

In some embodiments, the UE 302 may determine that the LTM procedure is completed when the UE 302 delivers the LTM access information (e.g., via Msg3 216) to the C-PCell1 306. In some embodiments, the UE 302 may determine that the LTM procedure is completed when the UE 302 receives network LTM confirmation. The LTM confirmation may be the MAC CE (e.g., via Msg4 318).

In some embodiments, the UE 302 may use an LTM timer to help the UE 302 detect failure cases. For example, the UE 302 may assume the LTM procedure failed upon RACH failure or when the LTM timer expires. In some embodiments, the LTM timer may be started when the UE 302 receives the PDCCH order 310. In some embodiments, the LTM timer may be started when the UE 302 transmits the preamble 312 to the C-PCell1 306.

FIG. 4 illustrates a signal flow diagram 400 of an LTM procedure where the RAR is used as the LTM command for a CFRA case. The UE 402 and the S-PCell 404 may execute a candidate cell configuration. The candidate cell configuration may include the S-PCell 404 transmitting an RRC reconfiguration message 408 to the UE 402. The RRC reconfiguration message 408 may contain an LTM candidate configuration. The UE 402 may transmit an RRC reconfiguration complete message 410 to the S-PCell 404 to indicate reception of the RRC reconfiguration message 508.

The S-PCell 404 may transmit a PDCCH order 412 to the UE 402 to initiate a RACH procedure. The PDCCH order 412 may include cell information for the C-PCell1 406. For example, the PDCCH order 412 may include a cell index of C-PCell1 406 or a candidate configuration index of C-PCell1 406. The PDCCH order 412 may also include a preamble index and PRACH resource that refers to C-PCell1 PRACH configuration. When the UE 402 receives the PDCCH order 412, the UE 402 switches to C-PCell1 406 and performs a preamble 414 transmission. The UE 402 applies the C-PCell1 RACH configuration and performs CFRA in C-PCell1 406.

During the RACH procedure, the UE 402 may perform the following operations.

The UE 402 may transmit the preamble 414 to the C-PCell1 406. The preamble 414 may be determined using the preamble index and PRACH resource from the PDCCH order 412.

After transmitting the preamble 414, the UE 402 may switch back to the S-PCell 404 and monitor for a random access response (RAR 416) from the S-PCell 404. The S-PCell 404 may send the RAR 416 to the UE 402. The UE 402 may receive the RAR 416 from the S-PCell 404. The uplink grant in the RAR 416 refers to the resource in C-PCell1 406. The RAR 416 may include candidate configuration index of the C-PCell1 406. The RAR 416 may also include an LTM command indication that indicates to the UE 402 a purpose of the RAR 416. For example, the LTM command indication may be 1-bit that indicates whether to switch cell or just obtain a second TA for C-PCell1 406 with cell switching.

The UE 402 transmits the LTM access information to the network via the uplink grant indicated in RAR 416. The illustrated embodiment is for CFRA, and the LTM access information is transmitted to the C-PCell1 406 via the UE dedicated UL transmission 418. In some embodiments, the TC-RNTI in RAR 416 can be the C-RNTI allocated to the UE 402 for dedicated transmission.

In some embodiments, the RAR may be delivered via C-PCell. In such embodiments, the LTM command info can be decided by C-PCell, or decided by S-PCell. If the switch is decided by S-PCell, SPCell can inform the decision to C-PCell and C-PCell may deliver it to UE.

In some embodiments, the UE 402 may determine that the LTM procedure is completed when the UE 402 delivers the LTM access information to the network. In some embodiments, the UE 402 may determine that the LTM procedure is completed when the UE 402 receives network LTM confirmation. The LTM confirmation may be provided via MAC CE.

In some embodiments, the UE 402 may use an LTM timer to help the UE 402 detect failure cases. For example, the UE 402 may assume the LTM procedure failed upon RACH failure or when the LTM timer expires. In some embodiments, the LTM timer may be started when the UE 402 receives the RAR 416. In some embodiments, the LTM timer may be started when the UE 402 transmits the LTM access info to network.

FIG. 5 illustrates a signal flow diagram 500 of an LTM procedure where the Msg4 is used as the LTM command for a CBRA case. The UE 502 and the S-PCell 504 may execute a candidate cell configuration. The candidate cell configuration may include the S-PCell 504 transmitting an RRC reconfiguration message 508 to the UE 502. The RRC reconfiguration message 508 may contain an LTM candidate configuration. The UE 502 may transmit an RRC reconfiguration complete message 510 to the S-PCell 504 to indicate reception of the RRC reconfiguration message 508.

The S-PCell 504 may transmit a PDCCH order 512 to the UE 502 to initiate a RACH procedure. The PDCCH order 512 may include cell information for the C-PCell1 506. For example, the PDCCH order 512 may include a cell index of C-PCell1 506 or a candidate configuration index of C-PCell1 506. The PDCCH order 512 may also include a preamble index and PRACH resource that refers to C-PCell1 PRACH configuration. When the UE 502 receives the PDCCH order 512, the UE 502 switches to C-PCell1 506 and performs a preamble 514 transmission. The UE 502 applies the C-PCell1 RACH configuration and performs RACH in C-PCell1 506.

During the RACH procedure, the UE 502 may perform the following operations.

The UE 502 may transmit the preamble 514 to the C-PCell1 506. The preamble 514 may be determined using the preamble index and PRACH resource from the PDCCH order 512.

After transmitting the preamble 514, the UE 502 may switch back to the S-PCell 504 and monitor for a random access response (RAR 516) from the S-PCell 504. The S-PCell 504 may send the RAR 516 to the UE 502. The UE 502 may receive the RAR 516 from the S-PCell 504. The UE 502 may transmit Msg3 518 that may include UE C-RNTI via S-PCell 504 according to the UL grant in RAR 516.

In some embodiments, for Msg2 (e.g., RAR 516), Msg3 518, and/or Msg4 520, the UE 502 can communicate with the C-PCell 506. In such embodiments, in Msg3, UE 502 can indicate the S-PCell index and C-RNTI. C-PCell 506 may decide to switch UE 502 from S-PCell 504 to C-PCell 506, and send the cell switch command via C-PCell 506. In some embodiments, C-PCell 506 may coordinate with S-PCell 504 first and S-PCell 504 may decide to switch UE 502, and C-PCell 506 may deliver the switch command to UE 502 via its link.

The UE 502 may receive the network explicit UL scheduling within contention resolution window. For example, the uplink grant in Msg4 520 may be sent from the S-PCell 504 and may refer to the source in C-PCell1 506. The network (e.g., S-PCell 504) may explicitly indicate the Msg4 520 is for the LTM command purpose. In some embodiments, the UE 502 may determine the Msg4 520 is for the LTM command purpose if it provides an uplink grant for the C-PCell1 506 and not for S-PCell 504 that sent it.

When the UE 502 receives the Msg4 520, the UE 502 may switch to C-PCell1 506, and apply the C-PCell1 configuration. The UE 502 may start the transmission 522 in C-PCell1 506 according to the UL grant in Msg4 520. The UE 502 may need special timing defined in some embodiments.

In some embodiments, the UE 502 may determine that the LTM procedure is completed when the UE 502 delivers the LTM access information to the network. In some embodiments, the UE 502 may determine that the LTM procedure is completed when the UE 502 receives network LTM confirmation. The LTM confirmation may be provided via MAC CE.

In some embodiments, the UE 502 may use an LTM timer to help the UE 502 detect failure cases. For example, the UE 502 may assume the LTM procedure failed upon RACH failure or when the LTM timer expires. In some embodiments, the LTM timer may be started when the UE 502 transmits the LTM access information to the network.

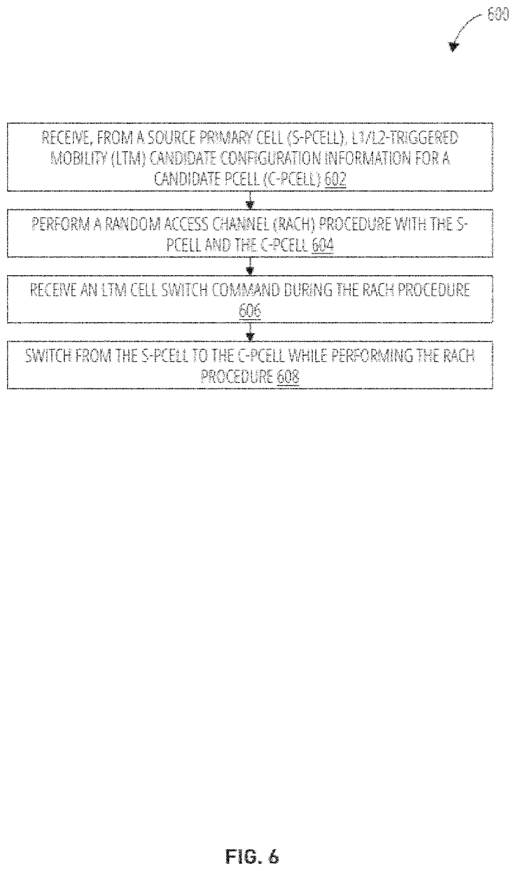

FIG. 6 illustrates a method 600 for a UE in accordance with some embodiments.

The method 600 includes receiving 602, from an S-PCell, LTM candidate configuration information for a C-PCell. The method 600 includes performing 604 a random access channel (RACH) procedure with the S-PCell and the C-PCell. The method 600 includes receiving 606 an LTM cell switch command during the RACH procedure. The method 600 includes switching 608 from the S-PCell to the C-PCell while performing the RACH procedure.

In some embodiments, the LTM cell switch command is received via a physical downlink control channel (PDCCH) order, wherein the PDCCH order comprises: a cell index of the C-PCell or a candidate configuration index of the C-PCell; and an LTM command indication that indicates whether the PDCCH order is for a cell switch.

In some embodiments, the method 600 further comprises stopping data transmission with the S-PCell and switching to the C-PCell to perform the RACH procedure after receiving the PDCCH order.

In some embodiments, the LTM cell switch command is received via a random access response (RAR), wherein the RAR comprises: a cell index of the C-PCell or a candidate configuration index of the C-PCell; and an LTM command indication that indicates whether the RAR is for a cell switch.

In some embodiments, the method 600 further comprises: receiving a physical downlink control channel (PDCCH) order from the S-PCell; transmitting a preamble to the C-PCell; and receiving the RAR from the S-PCell.

In some embodiments, the LTM cell switch command is received via a contention resolution message.

In some embodiments, the method 600 further comprises: receiving a physical downlink control channel (PDCCH) order from the S-PCell; transmitting a preamble to the C-PCell; receiving a random access response (RAR) from the S-PCell; transmitting a message from the UE comprising a Cell Radio Network Temporary Identifier (C-RNTI) via Msg3; and receiving the contention resolution message from the S-PCell.

Embodiments contemplated herein include an apparatus comprising means to perform one or more elements of the method 600. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 600. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a UE (such as a wireless device 902 that is a UE, as described herein).

Embodiments contemplated herein include a signal as described in or related to one or more elements of the method 600.

Embodiments contemplated herein include a computer program or computer program product comprising instructions, wherein execution of the program by a processor is to cause the processor to carry out one or more elements of the method 600. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

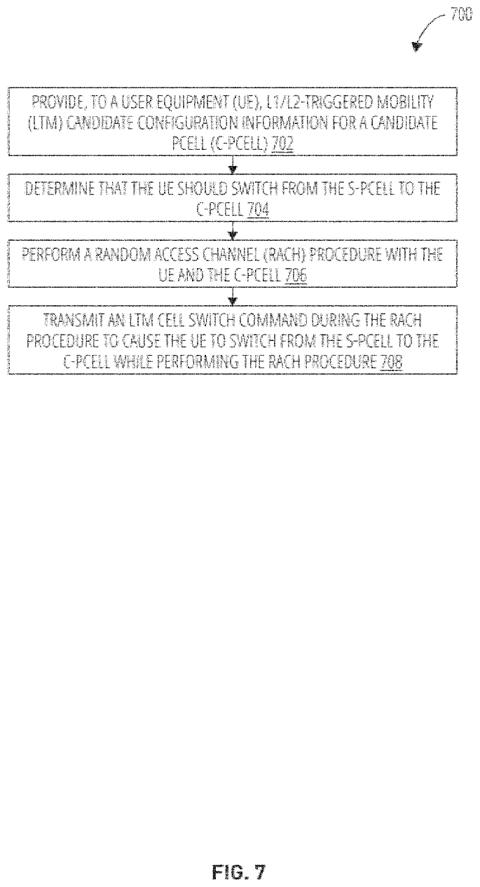

FIG. 7 illustrates a method 700 for an S-PCell in accordance with some embodiments. The method 700 includes providing 702, to a UE, LTM candidate configuration information for a C-PCell. The method 700 includes determining 704 that the UE should switch from the S-PCell to the C-PCell. The method 700 includes performing 706 a RACH procedure with the UE and the C-PCell. The method 700 includes transmitting 708 an LTM cell switch command during the RACH procedure to cause the UE to switch from the S-PCell to the C-PCell while performing the RACH procedure.

In some embodiments, the LTM cell switch command is received via a physical downlink control channel (PDCCH) order, wherein the PDCCH order comprises: a cell index of the C-PCell or a candidate configuration index of the C-PCell; and an LTM command indication that indicates whether the PDCCH order is for a cell switch.

In some embodiments, the method 700 further comprises stopping data transmission with the UE after sending the PDCCH order.

In some embodiments, the LTM cell switch command is received via a random access response (RAR), wherein the RAR comprises: a cell index of the C-PCell or a candidate configuration index of the C-PCell; and an LTM command indication that indicates whether the RAR is for a cell switch.

In some embodiments, the method 700 further comprises transmitting a physical downlink control channel (PDCCH) order to the UE.

In some embodiments, the LTM cell switch command is received via a contention resolution message.

In some embodiments, the method 700 further comprises: transmitting a physical downlink control channel (PDCCH) order to the UE; transmitting a random access response (RAR) to the UE after the UE transmits a preamble to the C-PCell; and receiving a message from the UE comprising a Cell Radio Network Temporary Identifier (C-RNTI) via Msg3.

Embodiments contemplated herein include an apparatus comprising means to perform one or more elements of the method 700. This apparatus may be, for example, an apparatus of a base station (such as a network device 918 that is a base station, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 922 of a network device 918 that is a base station, as described herein).

Embodiments contemplated herein include an apparatus comprising logic, modules, or circuitry to perform one or more elements of the method 700. This apparatus may be, for example, an apparatus of a base station (such as a network device 918 that is a base station, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a network device 918 that is a base station, as described herein).

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 920 of a network device 918 that is a base station, as described herein). These instructions may be, for example, located in the processor and/or on a memory of the base station (such as a memory 922 of a network device 918 that is a base station, as described herein).

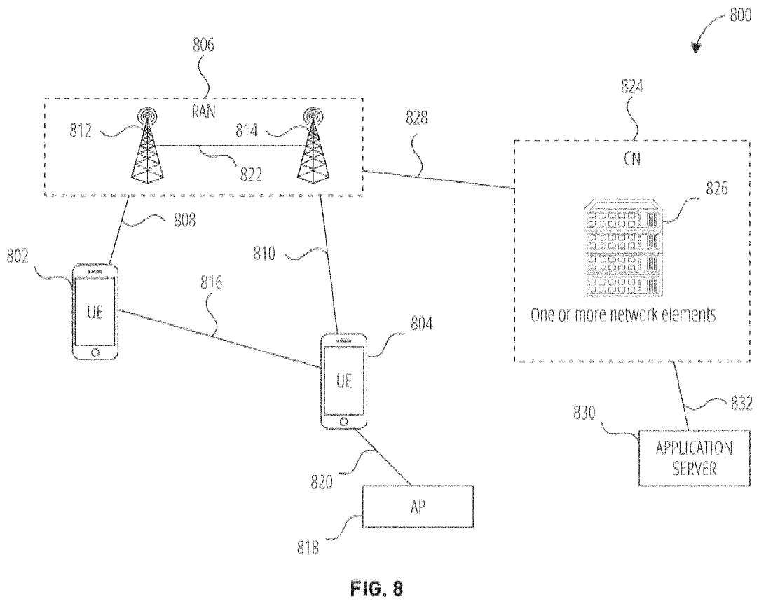

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations (such as base station 812 and base station 814) that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

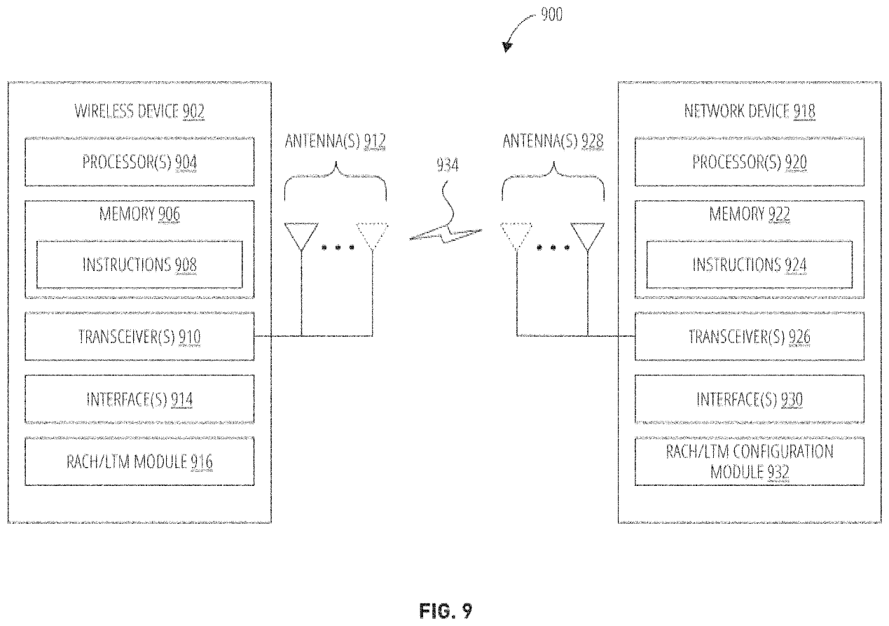

FIG. 9 illustrates a system 900 for performing signaling 934 between a wireless device 902 and a network device 918, according to embodiments disclosed herein. The system 900 may be a portion of a wireless communications system as herein described. The wireless device 902 may be, for example, a UE of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 934) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include a RACH/LTM module 916. The RACH/LTM module 916 may be implemented via hardware, software, or combinations thereof. For example, the RACH/LTM module 916 may be implemented as a processor, circuit, and/or instructions 908 stored in the memory 906 and executed by the processor(s) 904. In some examples, the RACH/LTM module 916 may be integrated within the processor(s) 904 and/or the transceiver(s) 910. For example, the RACH/LTM module 916 may be implemented by a combination of software components (e.g., executed by a DSP or a general processor) and hardware components (e.g., logic gates and circuitry) within the processor(s) 904 or the transceiver(s) 910.

The RACH/LTM module 916 may be used for various aspects of the present disclosure, for example, aspects of FIGS. 2-6. The RACH/LTM module 916 is configured to perform a RACH based LTM procedure.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter and/or receiver circuitry that use the antenna(s) 928 of the network device 918 to facilitate signaling (e.g., the signaling 934) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

The network device 918 may include a RACH/LTM configuration module 932. The RACH/LTM configuration module 932 may be implemented via hardware, software, or combinations thereof. For example, the RACH/LTM configuration module 932 may be implemented as a processor, circuit, and/or instructions 924 stored in the memory 922 and executed by the processor(s) 920. In some examples, the RACH/LTM configuration module 932 may be integrated within the processor(s) 920 and/or the transceiver(s) 926. For example, the RACH/LTM configuration module 932 may be implemented by a combination of software components (e.g., executed by a DSP or a general processor) and hardware components (e.g., logic gates and circuitry) within the processor(s) 920 or the transceiver(s) 926.

The RACH/LTM configuration module 932 may be used for various aspects of the present disclosure, for example, aspects of FIGS. 2-5 and 7. The RACH/LTM configuration module 932 is configured to configure the wireless device 902 for a RACH based LTM procedure.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein.

For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), the method comprising:
receiving, from a source primary cell (S-PCell), L1/L2-triggered mobility (LTM) candidate configuration information for a candidate PCell (C-PCell);
performing a random access channel (RACH) procedure with the S-PCell and the C-PCell;
receiving an LTM cell switch command during the RACH procedure; and
switching from the S-PCell to the C-PCell while performing the RACH procedure.

2. The method of claim 1, wherein the LTM cell switch command is received via a physical downlink control channel (PDCCH) order, wherein the PDCCH order comprises:
a cell index of the C-PCell or a candidate configuration index of the C-PCell; and
an LTM command indication that indicates whether the PDCCH order is for a cell switch.

3. The method of claim 2, further comprising stopping data transmission with the S-PCell and switching to the C-PCell to perform the RACH procedure after receiving the PDCCH order.

4. The method of claim 1, wherein the LTM cell switch command is received via a random access response (RAR), wherein the RAR comprises:
a cell index of the C-PCell or a candidate configuration index of the C-PCell; and
an LTM command indication that indicates whether the RAR is for a cell switch.

5. The method of claim 4, further comprising:
receiving a physical downlink control channel (PDCCH) order from the S-PCell;
transmitting a preamble to the C-PCell; and
receiving the RAR from the S-PCell or the C-PCell.

6. The method of claim 1, wherein the LTM cell switch command is received via a contention resolution message.

7. The method of claim 6, further comprising:
receiving a physical downlink control channel (PDCCH) order from the S-PCell;
transmitting a preamble to the C-PCell;
receiving a random access response (RAR) from the S-PCell or the C-PCell;
transmitting a message, to the S-PCell the C-PCell, comprising a Cell Radio Network Temporary Identifier (C-RNTI) via Msg3; and
receiving the contention resolution message from the S-PCell or the C-PCell.

8. A method for a source primary cell (S-PCell), the method comprising:
providing, to a user equipment (UE), L1/L2-triggered mobility (LTM) candidate configuration information for a candidate PCell (C-PCell);
determining that the UE should switch from the S-PCell to the C-PCell;
performing a random access channel (RACH) procedure with the UE and the C-PCell; and
transmitting an LTM cell switch command during the RACH procedure to cause the UE to switch from the S-PCell to the C-PCell while performing the RACH procedure.

9. The method of claim 8, wherein the LTM cell switch command is transmitted via a physical downlink control channel (PDCCH) order, wherein the PDCCH order comprises:
a cell index of the C-PCell or a candidate configuration index of the C-PCell; and
an LTM command indication that indicates whether the PDCCH order is for a cell switch.

10. The method of claim 9, further comprising stopping data transmission with the UE after sending the PDCCH order.

11. The method of claim 8, wherein the LTM cell switch command is transmitted via a random access response (RAR), wherein the RAR comprises:
a cell index of the C-PCell or a candidate configuration index of the C-PCell; and
an LTM command indication that indicates whether the RAR is for a cell switch.

12. The method of claim 11, further comprising transmitting a physical downlink control channel (PDCCH) order to the UE.

13. The method of claim 8, wherein the LTM cell switch command is transmitted via a contention resolution message.

14. The method of claim 13, further comprising:
transmitting a physical downlink control channel (PDCCH) order to the UE;
transmitting a random access response (RAR) to the UE after the UE transmits a preamble to the C-PCell; and
receiving a message from the UE comprising a Cell Radio Network Temporary Identifier (C-RNTI) via Msg3.

15. A user equipment (UE) comprising:
a processor; and
a memory storing instructions that, when executed by the processor, configure the UE to:
receive, from a source primary cell (S-PCell), L1/L2-triggered mobility (LTM) candidate configuration information for a candidate PCell (C-PCell);
perform a random access channel (RACH) procedure with the S-PCell and the C-PCell;
receive an LTM cell switch command during the RACH procedure; and
switch from the S-PCell to the C-PCell while performing the RACH procedure.

16. The UE of claim 15, wherein the LTM cell switch command is received via a physical downlink control channel (PDCCH) order, wherein the PDCCH order comprises:
a cell index of the C-PCell or a candidate configuration index of the C-PCell; and
an LTM command indication that indicates whether the PDCCH order is for a cell switch.

17. The UE of claim 16, wherein the instructions further configure the UE to stop data transmission with the S-PCell and switching to the C-PCell to perform the RACH procedure after receiving the PDCCH order.

18. The UE of claim 15, wherein the LTM cell switch command is received via a random access response (RAR), wherein the RAR comprises:
a cell index of the C-PCell or a candidate configuration index of the C-PCell; and
an LTM command indication that indicates whether the RAR is for a cell switch.

19. The UE of claim 18, wherein the instructions further configure the UE to:
receive a physical downlink control channel (PDCCH) order from the S-PCell;
transmit a preamble to the C-PCell; and
receive the RAR from the S-PCell.

20. The UE of claim 15, wherein the LTM cell switch command is received via a contention resolution message.
